(19) United States
(12) Patent Application Publication
(10) Pub. No.: US 2012/0170141 A1
(43) Pub. Date: Jul. 5, 2012

(54) Reading Optical Lens Module

(75) Inventors: Ming-Che Kuo, Taipei City (TW); San-Woei Shyu, Taipei City (TW)

(73) Assignee: E-PIN OPTICAL INDUSTRY CO., LTD., Taipei City (TW)

(21) Appl. No.: 13/167,428

(22) Filed: Jun. 23, 2011

(30) Foreign Application Priority Data
Dec. 30, 2010 (TW) 099146970

(51) Int. Cl. G02B 13/18

(52) U.S. Cl. 359/717

(57) ABSTRACT

A reading optical lens module, along an optical axis, comprising: two lens elements of meniscus shape, an aperture stop and an image sensor, wherein the first lens element with its convex surface on the object side having bi-aspherical surfaces and the second lens element with its convex surface on the image side having bi-aspherical surfaces, the aperture stop aligning between the first element and the second lens element and the image sensor disposing on the image plane for converting the objective image to electrical signal. Additionally, the reading optical lens module satisfies conditions related to reduction of total length, expansion of field of view angle and increase of resolution for use in the compact bar-code reader machine.

### BACKGROUND OF THE INVENTION

1. Field of the Invention

The present invention relates to an image reading lens module; in particular, it relates to an image reading lens module comprising two lenses and designed with regards to the wide field of angle requirement in compact scanning device applications.

2. Description of Related Art

Typically, the essential objective of a scanning device is to read an image with an image reading lens module and form an image onto an image sensor which then converts the image into electronic signals transferred to the outside. In order to prevent distortions in imaging processes or to compensate for light rays of different wavelengths, the design of optical reading lens plays a critical role.

For example, as disclosed in U.S. Pat. No. 6,147,816, a double-lens image reading lens module uses two meniscus lenses to constitute such an image reading lens module applicable to image scanners or facsimile machines. As shown in FIG. 1A, the image reading lens module 91 comprises a first lens 911 with the meniscus convex surface thereof facing toward the object side, a second lens 912 with the meniscus concave surface thereof facing toward the object side, a middle aperture diaphragm 913 and an infrared filter 915 thereby forming an image on the imaging plane 914. It basically employs the second lens 912 having the diffractive aspherical optical surface to reduce the astigmatic aberration and chromatic dispersion so as to enhance the color resolution in the scanned image. However, the field of angle designed in this fashion is insufficient, half of which can reach only up to roughly 23.6°, incapable of application to the image reading lens module employed in compact bar code reader machines essentially due to the requirement of close distance from the bar code image that such compact bar code reader machines needs to read to the image reading lens module, which demands a wider field of angle.

An image reading lens module for the bar code reader machine is disclosed in US Patent Publication US 2009/0140048 which adopts a receiving lens positioned at the diffractive end of a compound parabolic concentrator thereby increasing the field of angle; whereas it is challenging to fabricate its lens structure and the receiving lens has a significant length thus adversely affecting the purpose of miniaturization. Furthermore, ROC Patent TWM306698 also discloses a single-pieced image reading lens module which is more convenient to manufacture, but requires even longer reception distance thus reducing the usability thereof

Hence, in order to improve the quality of the received image, U.S. Pat. No. 5,917,661 discloses an image reading lens module using two optical lenses, as shown in FIG. 1B, in which the image reading lens module 92 comprises a bi-convex first lens 921, a meniscus second lens 922 with the concave surface thereof located at the object side, and a rear aperture diaphragm 923 thereby forming an image on an imaging plane 924. Herein the image reading lens module 92 is a double lens combination including the bi-convex first lens 921 and the meniscus second lens 922 which enables wider angle of view through the lens with higher refraction power achieved by increasing the thickness of the lens, thus adversely causing inconvenience in manufacture processes and being unable to apply to compact (thin) bar code reader machines.

Regarding to the design of image reading lens module suitable for high resolution bar code reader machines, as the four lens image reading lens module disclosed in U.S. Pat. No. 7,477,460 or US Patent Publication US2007/0097522, better compensation in astigmatic aberration can be achieved but the integral length thereof is nonetheless too long, and more lenses are needed, which is not cost-effective.

At present, on the development trend in bar code reader machines, intensive user needs for small-sized, short range operations between the bar code reader machine and the bar code exist, it is therefore advantageous to fulfill such demands with an image reading lens module featuring a shortened lens module length (entire length), wide angle of view, reduced back focal length as well as high resolution through effective astigmatic aberration corrections.

### SUMMARY OF THE INVENTION

Considering the aforementioned issues found in prior art, one main objective of the present invention lies in providing a reading optical lens module which enables a wider angle of view, shorter back focal length and better corrected astigmatic aberration for applications on the bar code reader machine requiring small size and short range scanning. The reading optical lens module comprises a first lens, a second lens and an image sensor arranged sequentially from the object side to the image side and along an optical axis.

Herein the first lens is a meniscus lens whose object side optical surface is a convex surface facing toward the object side, and the object side optical surface and the image side optical surface of the first lens are both aspherical surfaces. Herein the second lens is a meniscus lens whose object side optical surface is a concave surface facing toward the object side, and the object side optical surface and the image side optical surface of the second lens are both aspherical surfaces. Moreover, the first lens and the second lens are selected to have the same refractive Index N_{d}. Herein the image sensor is disposed on an imaging plane formed after combination of the first lens and the second lens, and the reading optical lens module satisfies the following conditions:

62.0°<2ω<89.5° (1)

1.50<TL/D_{1/2}=2.20 (2)

wherein 2ω denotes the diagonal angle of the field of view for the reading optical lens module (in degrees), TL denotes the distance between the object side optical surface of the first lens and the imaging plane, and D_{1/2} represents half of the length of the diagonal line in the effective sensing area provided by the image sensor.

Another objective of the present invention lies in providing a reading optical lens module as previously described, which comprises a first lens, a second lens and an image sensor arranged sequentially from the object side to the image side and along an optical axis, and further satisfies one of the following conditions or a combination thereof:

1.0<|f/f₁|+|f/f₂|<2.1 (3)

1.10<R₁/R₂<1.50 (4)

1.35<(R₃+R₄)/(R₃−R₄)<2.50 (5)

wherein f denotes the focal length of the reading optical lens module, f₁ denotes the focal length of the first lens, f₂ denotes the focal length of the second lens, R₁ denotes the paraxial radius of curvature on the object side optical surface of the first lens, R₂ denotes the paraxial radius of curvature on the image side optical surface of the first lens, R₃ denotes the paraxial radius of curvature on the object side optical surface of the second lens and R₄ denotes the paraxial radius of curvature on the image side optical surface of the second lens.

According to another main objective of the present invention, a reading optical lens module is provided which enables a wider angle of view, shorter back focal length and better corrected astigmatic aberration for applications on the bar code reader machine requiring small size and short range scanning. From the object side to the image side, the reading optical lens module comprises a first lens, an aperture stop, a second lens and an image sensor arranged along an optical axis sequentially.

Herein the first lens is a meniscus lens whose object side optical surface is a convex surface facing toward the object side, and the object side optical surface and the image side optical surface of the first lens are both aspherical surfaces. Herein the aperture stop is a middle aperture diaphragm for blocking stray light. Herein the second lens is a meniscus lens whose object side optical surface is a concave surface facing toward the object side, and the object side optical surface and the image side optical surface of the second lens are both aspherical surfaces. Herein the image sensor is disposed on the imaging plane formed after combination of the first lens and the second lens, and the reading optical lens module further satisfies the following condition in addition to the aforementioned conditions of conditions (1) and (2):

0.58<BFL/TL<0.79 (6)

wherein BFL denotes the back focal length of the reading optical lens module, and TL denotes the distance from the object side optical surface of the first lens to the imaging plane on the optical axis.

According to yet another objective of the present invention, a reading optical lens module for the bar code reader machine as previously described is provided for facilitating the generation of chromatic dispersion due to light rays of different wavelengths in the reading optical lens module for the bar code reader machine, further satisfying the following condition in addition to the aforementioned conditions of conditions (1) and (2):

|v_{d1}−v_{d2}|/v_{d1}<0.08 (7)

where v_{d1} denotes the coefficient of dispersion in the first lens and v_{d2} denotes the coefficient of dispersion in the second lens. Furthermore, to reduce material preparations in manufacture processes, the first lens and the second lens may be made of the material having the same dispersion coefficient V_{d}.

In the reading optical lens module according to the present invention, the first lens and the second lens may be made of the glass or plastic material, and the present invention is not limited thereto.

In summary of the above-said descriptions, the reading optical lens module according to the present invention features one or more of the following advantages:

(1) the reading optical lens module according to the present invention allows to increase the amplitude of refraction, adjust the spherical aberration and the astigmatic field curving as well as correct the distortion through two meniscus lenses combined in different directions;

(2) the reading optical lens module according to the present invention can achieve a wider angle of view by means of restrictions indicated in condition (1) thereby successful reading the bar code image at a closer distance; further through the limitation of condition (2), it is possible to reduce the distance from the object side optical surface of the first lens to the imaging plane (TL) with half of the diagonal line of the effective sensing area of the image sensor in the unit length (D_{1/2}) thus achieving the objective of miniaturization of the reading optical lens module; and also based on the additional limitation of condition (6) and the additional limitation of a middle aperture stop, the back focal length (BFL) of the reading optical lens module can be advantageously reduced with the same distance from the object side optical surface of the first lens to the imaging plane (TL) so as to facilitate the miniaturization (slimness) of the reading optical lens module;

(3) the reading optical lens module according to the present invention allows to, by means of additional limitation of condition (3), regulate the refraction power between the first lens and the second lens such that the distribution of the refraction power can be more balanced in order to reduce the sensitivity of the integral system and occurrence of aberration thereby fulfilling the goal of good imaging feature. Furthermore, by means of additional limitation of condition (4), it is possible to enhance the refraction power of the first lens so as to shorten the entire length of the reading optical lens module; and via additional restriction described in condition (5), the profile of the second lens can be advantageously confined in order to facilitate manufacturing.

(4) the reading optical lens module according to the present invention allows to, with regards to further limitations of condition (7), generate the chromatic dispersion to increase the resolution of the image, such as a barcode, due to light rays of different wavelengths, further enabling the use of material having the identical dispersion coefficient for the first lens and the second lens thereby simplifying manufacture materials and reducing manufacture costs.

### BRIEF DESCRIPTION OF THE DRAWINGS

FIG. 1A shows a diagram of a prior art image reading lens module;

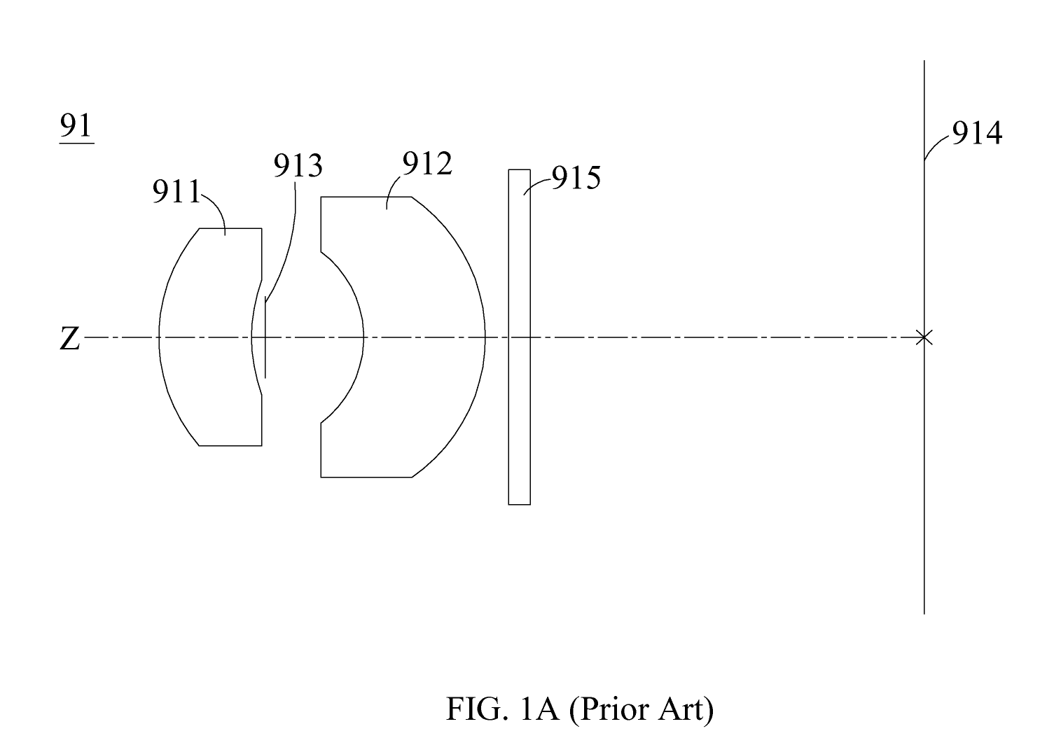

FIG. 1B shows a diagram of another prior art image reading lens module;

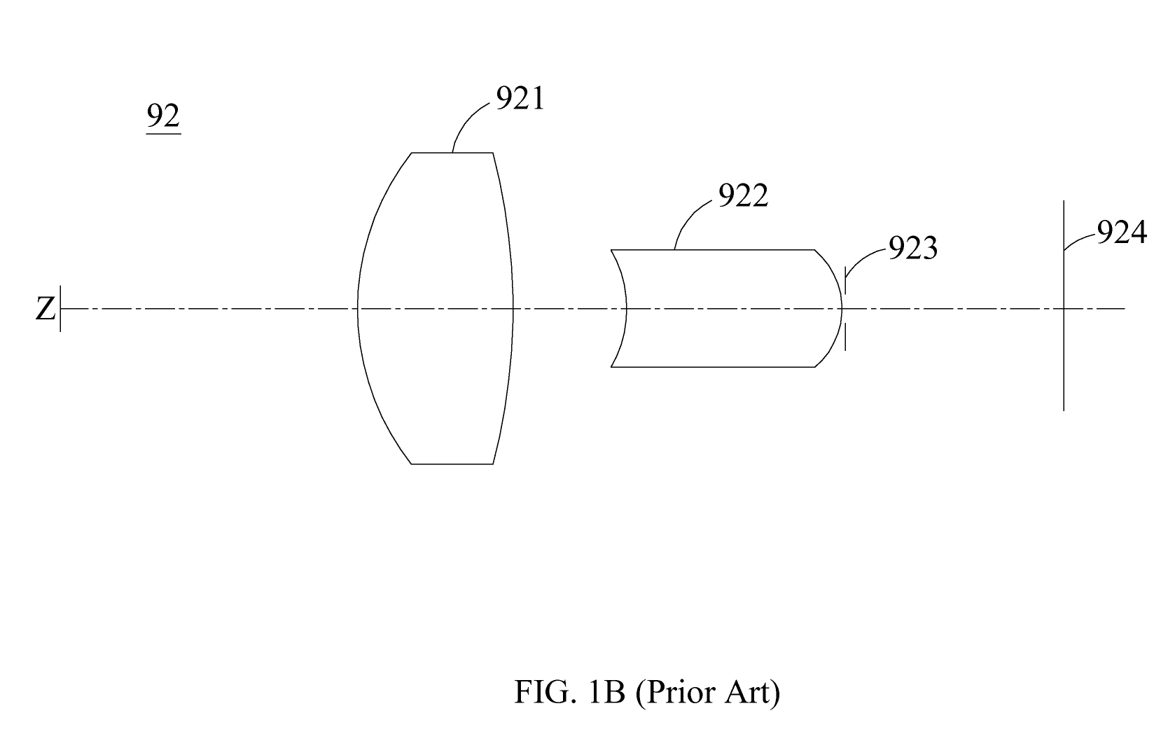

FIG. 2 shows a diagram of a reading optical lens module according to the present invention;

FIG. 3 shows a diagram of the light path in the reading optical lens module according to the present invention;

FIG. 4 shows a diagram of the astigmatic field curving and the distortion in the first embodiment of the reading optical lens module according to the present invention;

FIG. 5 shows a diagram of the astigmatic field curving and the distortion in the second embodiment of the reading optical lens module according to the present invention; and

FIG. 6 shows a diagram of the astigmatic field curving and the distortion in the third embodiment of the reading optical lens module according to the present invention.

### DETAILED DESCRIPTION OF THE PREFERRED EMBODIMENTS

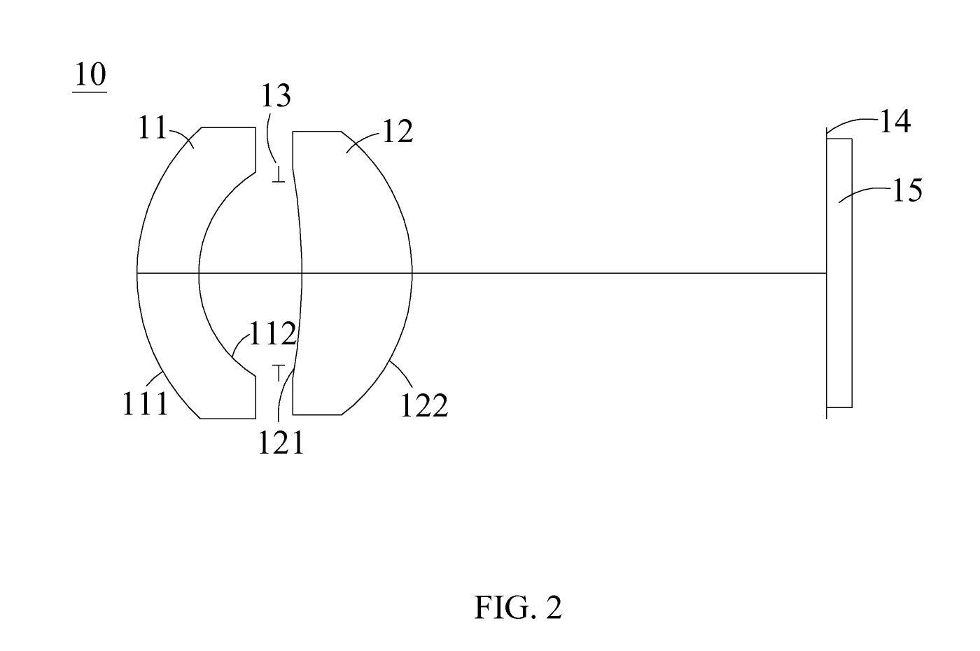

Referring initially to FIG. 2, a reading optical lens module according to the present invention is shown. The reading optical lens module 10 comprises, arranged along an optical axis in order from the object side to the image side, a first lens 11, a second lens 12, and an image sensor 15. Herein the first lens 11 is a meniscus lens, in which the object side optical surface 111 of the first lens is a convex surface and the image side optical surface 112 of the first lens is a concave surface; the second lens 12 is a meniscus lens, in which the object side optical surface 121 of the second lens is a concave surface and the image side optical surface 122 of the second lens is a convex surface; besides, the image sensor 15 is disposed on the imaging plane 14 formed after combination of the first lens 11 and the second lens 12. An aperture stop 13 can be installed inside the reading optical lens module 10, which is shown in the FIG. 2 as located between the first lens 11 and the second lens 12, indicating a type of middle aperture diaphragm; however, for other different applications, the aperture stop 13 may be otherwise installed between the first lens 11 and the barcode to be read, representing a type of front aperture diaphragm. The present invention is not limited thereto.

The object side optical surface 111 and the image side optical surface 112 of the first lens 11 can be aspherical surfaces, and the object side optical surface 121 and the image side optical surface 122 of the second lens 12 can be aspherical surfaces as well. The aspherical optical surfaces of the first lens 11 and the second lens 12 can be constructed based on the following aspherical surface formula (8):

$$Z = \frac{{cr}^{2}}{1 + \sqrt{( 1 - ( 1 + K ) {c}^{2} {r}^{2} )}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad ( 8 )$$

wherein Z denotes the distance from any point on the lens in the direction of optical axis to the tangential plane of the center of the lens (SAG); c denotes the curvature; r denotes the height of the lens perpendicular to the optical axis, K denotes the conic constant; and α₁˜α₈ denotes the aspherical coefficient for the second to the sixteenth order, respectively.

The reading optical lens module 10 according to the present invention will now be described in details through the subsequent embodiments in conjunction with the appended drawings.

### First Embodiment

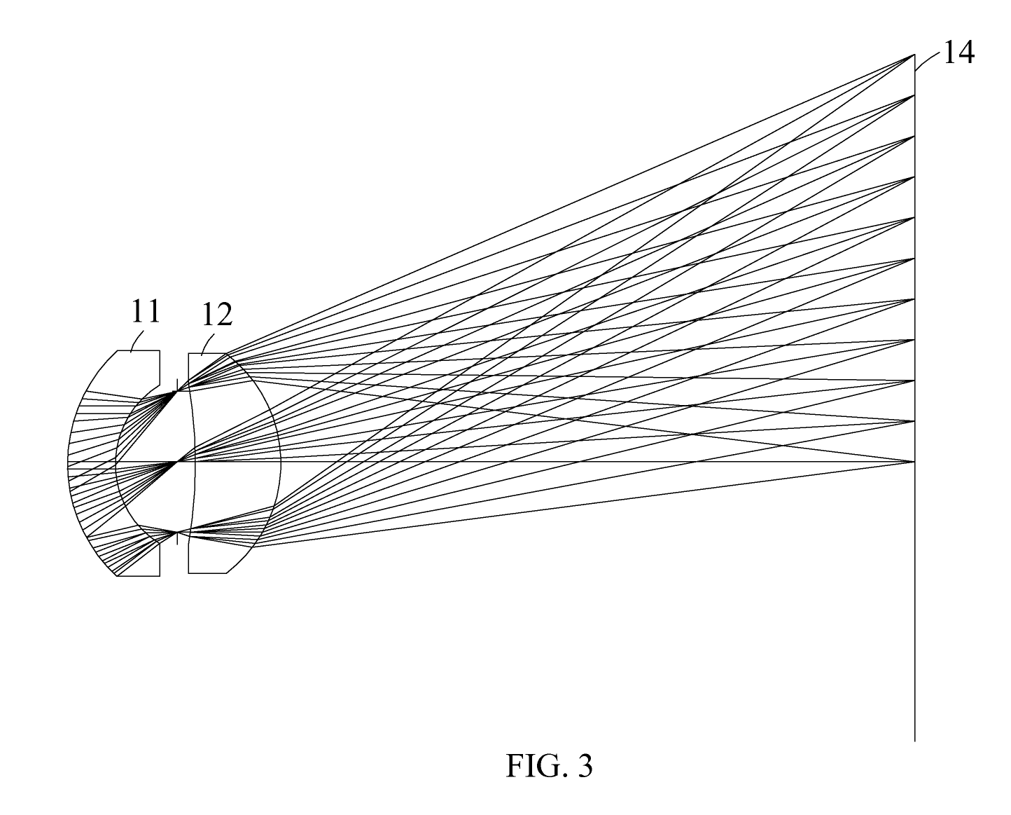

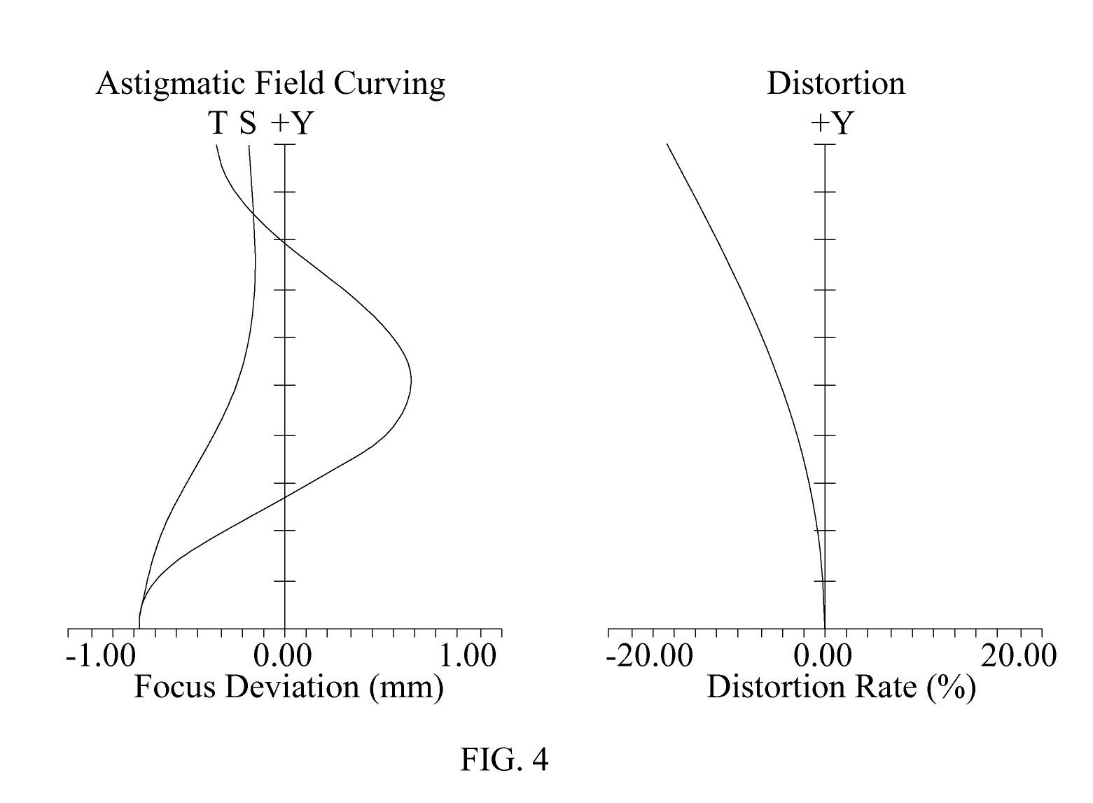

Refer to FIG. 2, a diagram depicting the first embodiment of the reading optical lens module according to the present invention is shown, whose light path diagram can be referred to FIG. 3, and the astigmatic aberration curve for the first embodiment can be referred to FIG. 4. The reading optical lens module 10 of the first embodiment comprises, arranged along the optical axis in order from the object side to the image side, a first lens 11, an aperture stop 13, a second lens 12 and an image sensor 15. Herein the first lens 11 is a meniscus lens, in which the object side optical surface 111 of the first lens is a convex surface, the image side optical surface 112 of the first lens is a concave surface, and the object side optical surface 111 and the image side optical surface 112 of the first lens are both aspherical surfaces constructed with the aspherical surface formula (8); the second lens 12 is a meniscus lens, in which the object side optical surface 121 of the second lens is a concave surface, the image side optical surface 122 of the second lens is a convex surface, and the object side optical surface 121 and the image side optical surface 122 of the second lens are both aspherical surfaces constructed with the aspherical surface formula (8); besides, the image sensor 15 is disposed on the imaging plane 14 formed after combination of the first lens 11 and the second lens 12. The optical data of the present embodiment is summarized in Table 1 as below.

TABLE 1
Optical Parameter Table of First Embodiment
Fno = 3.2 f = 8.59 FOV = 64.7

| Optical | | Radius of | Distance d | Refractive | Abbe |
|---|---|---|---|---|---|
| Surface | | Curvature R | (mm) | Index N_{d} | Number ν_{d} |
| 1 | OBJ | ∞ | 50.0000 | | |
| 2 | R1* | 2.2378 | 0.8356 | 1.53 | 56.00 |
| 3 | R2* | 1.5948 | 1.0905 | | |
| | STOP | | 0.3136 | | |
| 4 | R3* | −10.5218 | 1.4933 | 1.53 | 56.00 |
| 5 | R4* | −2.5469 | 11.2681 | | |
| 6 | IMA | ∞ | | | |

*represents aspherical surface

The object side optical surface of the first lens 111, the image side optical surface of the first lens 112, the object side optical surface of the second lens 121 and the image side optical surface of the second lens 122 are all aspherical surfaces constituted by means of the aspherical surface formula (8), whose aspherical coefficients are shown as below in Table 2.

TABLE 2
Aspherical Coefficient Table of First Embodiment

| Optical | | | | | | | |
|---|---|---|---|---|---|---|---|
| Surface | k | A4 | A6 | A8 | A10 | A12 | A14 |
| R1* | −3.1813E−01 | −1.5528E−03 | −2.0284E−03 | 8.1682E−04 | −5.1651E−04 | 1.0340E−04 | −8.1404E−06 |
| R2* | −5.1446E+00 | 1.7177E−01 | −1.1988E−01 | 8.6512E−02 | −3.3077E−02 | 3.9670E−03 | 7.4937E−04 |
| R3* | 1.7311E+01 | −9.7860E−03 | 1.1505E−02 | −9.2329E−03 | 2.9584E−03 | 1.3880E−04 | −1.3680E−04 |
| R4* | 4.6525E−01 | 7.2668E−03 | −8.2623E−03 | 4.6434E−03 | −9.7449E−04 | −2.1264E−05 | 2.7243E−05 |

In the reading optical lens module of the first embodiment, the focal length of the entire reading optical lens module 10 is f=8.59 (mm), the f-number of the constructed reading optical lens module is Fno=3.2, and the diagonal angle for the field of view (FOV) is 2ω=64.7 (in unit of degrees).

Refer back to Table 1, wherein, in the present embodiment, the dispersion coefficient for the first lens 11 of the reading optical lens module is represented as v_{d1}, the dispersion coefficient for the second lens 12 is represented as v_{d2}, with the following relationship: |v_{d1}−v_{d2}|/v_{d1}=0, which satisfies condition (7), as using the same material in design of the two lenses. On the optical axis, the distance from the object side optical surface of the first lens 111 to the imaging surface 14 is TL=15.01, and the half of the diagonal length in the effective sensing area of the image sensor is D_{1/2}=7.215, with TL/D_{1/2}=2.08 which satisfies condition (2). The back focal length of the reading optical lens module of the present embodiment is BFL=11.27, with BFL/TL=0.75 which satisfies condition (6). Furthermore, the focal length of the first lens 11 is f₁=−19.07 and the focal length of the second lens 12 is f₂=5.97, with |f/f₁|+|f/f₂|=1.89 which satisfies condition (3).

Referring to Table 1, in the present embodiment, the first lens 11 and the second lens 12 respectively satisfies conditions (4) and (5): R₁/R₂=1.40 and (R₃+R₄)/(R₃−R₄)=1.64.

It can be seen from the optical data listed in Table 1 and the astigmatic aberration curve shown in FIG. 4 that, through the present embodiment of the reading optical lens module according to the present invention, the astigmatic field curving and the distortion can be better compensated and a wider angle of view in the reading optical lens module can be well provided thereby offering the desirable effect of total length reduction.

### Second Embodiment

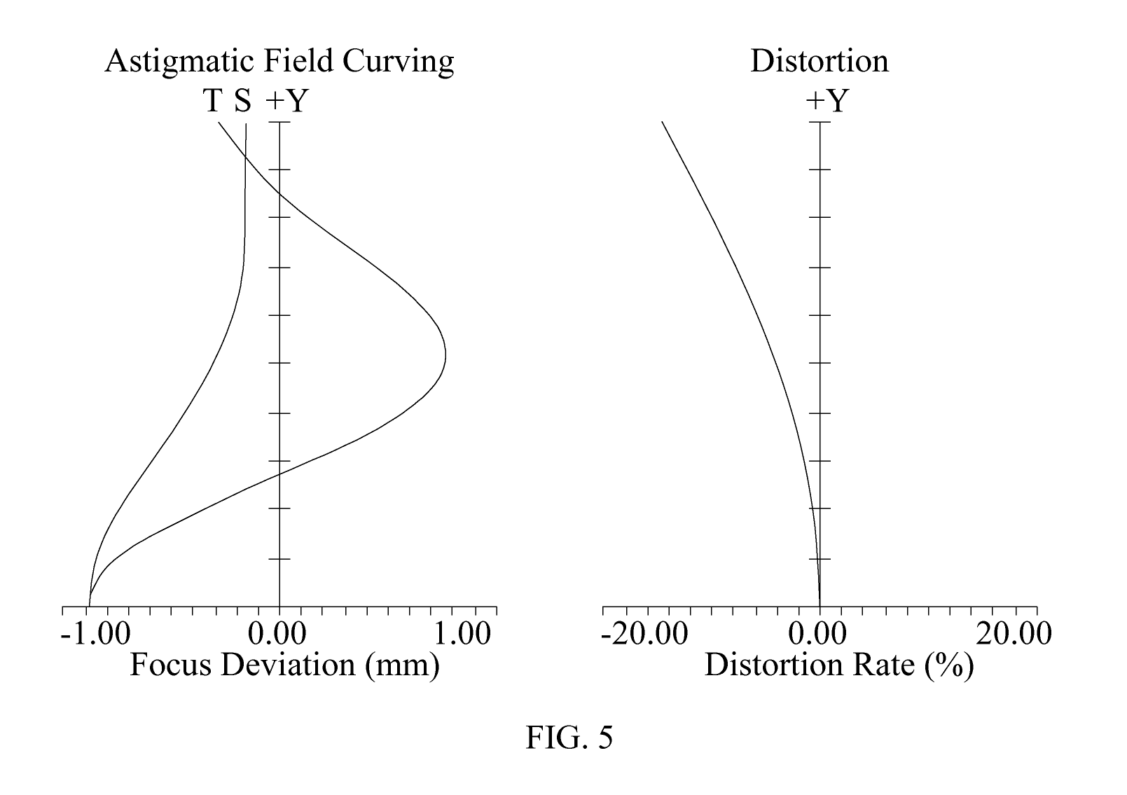

The astigmatic aberration curve for the second embodiment of the present invention can be referred to FIG. 5, in which the reading optical lens module 10 of the second embodiment comprises, arranged along the optical axis in order from the object side to the image side, a first lens 11, an aperture stop 13, a second lens 12 and an image sensor 15. Herein the first lens 11 is a meniscus lens, in which the object side optical surface 111 of the first lens is a convex surface, the image side optical surface 112 of the first lens is a concave surface, and the object side optical surface 111 and the image side optical surface 112 of the first lens are both aspherical surfaces constructed with the aspherical surface formula (8); the second lens 12 is a meniscus lens, in which the object side optical surface 121 of the second lens is a concave surface, the image side optical surface 122 of the second lens is a convex surface, and the object side optical surface 121 and the image side optical surface 122 of the second lens are both aspherical surfaces constructed with the aspherical surface formula (8); besides, the image sensor 15 is disposed on the imaging plane 14 formed after combination of the first lens 11 and the second lens 12. The optical data of the present embodiment is summarized in Table 3 as below.

TABLE 3
Optical Parameter Table of Second Embodiment
Fno = 3.2 f = 8.17 FOV = 69.3

| | | | | | Abbe |
|---|---|---|---|---|---|
| Optical | | Radius of | Distance d | Refractive | Number |
| Surface | | Curvature R | (mm) | Index N_{d} | ν_{d} |
| 1 | OBJ | ∞ | 50.0000 | | |
| 2 | R1* | 1.9678 | 0.6964 | 1.53 | 56.00 |
| 3 | R2* | 1.4987 | 0.9203 | | |
| | STOP | | 0.3092 | | |
| 4 | R3* | −10.0402 | 1.1785 | 1.53 | 56.00 |
| 5 | R4* | −2.4840 | 10.5278 | | |
| 6 | IMA | ∞ | | | |

*represents aspherical surface

The object side optical surface of the first lens 111, the image side optical surface of the first lens 112, the object side optical surface of the second lens 121 and the image side optical surface of the second lens 122 are all aspherical surfaces constituted by means of the aspherical surface formula (8) whose aspherical coefficients are shown as below in Table 4.

TABLE 4
Optical Parameter Table of Second Embodiment

| Optical | | | | | | | |
|---|---|---|---|---|---|---|---|
| Surface | k | A4 | A6 | A8 | A10 | A12 | A14 |
| R1* | −2.5590E−01 | −9.9455E−04 | −3.7726E−03 | 1.5988E−04 | −1.6233E−04 | −9.2805E−05 | 1.734643-5 |
| R2* | −3.0859E+00 | 1.5486E−01 | −1.1975E−01 | 1.0661E−01 | −3.8127E−02 | −4.4364E−03 | 4.8678E−03 |
| R3* | 2.2945E+01 | −9.2211E−03 | 1.5868E−02 | −1.1711E−02 | 3.3145E−03 | 1.0944E−03 | −3.7761E−04 |
| R4* | 2.7677E−01 | 7.1041E−03 | −1.4255E−02 | 8.3427E−03 | −1.4331E−03 | −5.7847E−04 | 1.9932E−04 |

In the reading optical lens module of the second embodiment, the focal length of the entire reading optical lens module 10 is f=8.17 (mm), the f-number of the constructed reading optical lens module is Fno=3.2, and the diagonal angle for the field of view (FOV) is 2ω=69.3 (in unit of degrees).

Refer back to Table 3, wherein, in the present embodiment, the dispersion coefficient for the first lens 11 of the reading optical lens module is represented as v_{d1}, the dispersion coefficient for the second lens 12 is represented as v_{d2}, with the following relationship: |v_{d1}−v_{d2}|/v_{d1}<0.018, which satisfies condition (7), as using the same material in design of the two lenses. On the optical axis, the distance from the object side optical surface of the first lens 111 to the imaging surface 14 is TL=13.63, and the half of the diagonal length in the effective sensing area of the image sensor is Dᵥ₂=7.215, with TL/D_{1/2}=1.89 which satisfies condition (2). The back focal length of the reading optical lens module of the present embodiment is BFL=10.53, with BFL/TL=0.77 which satisfies condition (6). Furthermore, the focal length of the first lens 11 is f₁=−24.43 and the focal length of the second lens 12 is f₂=5.925 with |f/f₁|+|f/f₂|=1.71 which satisfies condition (3).

Referring to Table 3, in the present embodiment, the first lens 11 and the second lens 12 respectively satisfies condition (4) and (5): R₁/R₂=1.31 and (R₃+R₄)/(R₃−R₄)=1.66.

It can be seen from the optical data listed in Table 3 and the astigmatic aberration curve shown in FIG. 5 that, through the present embodiment of the image reading lens module for the bar code reader machine according to the present invention, the astigmatic field curving and the distortion can be better compensated and a wider angle of view in the image reading lens module can be well provided thereby offering the desirable effect of total length reduction.

### Third Embodiment

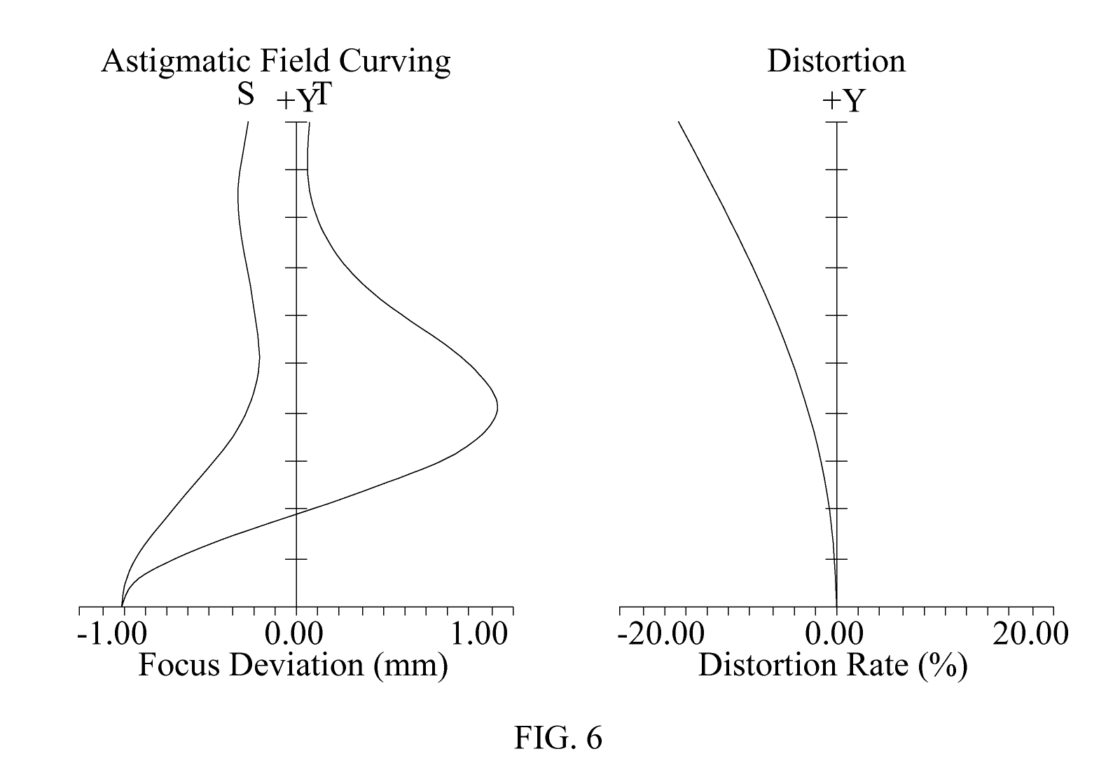

The astigmatic aberration curve for the third embodiment of the present invention can be referred to FIG. 6, in which the reading optical lens module 10 of the third embodiment, along the optical axis and sequentially arranged from the object side to the image side, comprises: a first lens 11, an aperture stop 13, a second lens 12 and an image sensor 15. Herein the first lens 11 is a meniscus lens, in which the object side optical surface 111 of the first lens is a convex surface, the image side optical surface 112 of the first lens is a concave surface, and the object side optical surface 111 and the image side optical surface 112 of the first lens are both aspherical surfaces constructed with the aspherical surface formula (8); the second lens 12 is a meniscus lens, in which the object side optical surface 121 of the second lens is a concave surface, the image side optical surface 122 of the second lens is a convex surface, and the object side optical surface 121 and the image side optical surface 122 of the second lens are both aspherical surfaces constructed with the aspherical surface formula (8); besides, the image sensor 15 is disposed on the imaging plane 14 formed after combination of the first lens 11 and the second lens 12. The optical data of the present embodiment is summarized in Table 5 as below.

TABLE 5
Optical Parameter Table of Third Embodiment
Fno = 3.2 f = 7.84 FOV = 88.3

| | | | | | Abbe |
|---|---|---|---|---|---|
| Optical | | Radius of | Distance d | Refractive | Number |
| Surface | | Curvature R | (mm) | Index N_{d} | ν_{d} |
| 1 | OBJ | ∞ | 50.0000 | | |
| 2 | R1* | 1.7111 | 0.6964 | 1.53 | 56.00 |
| 3 | R2* | 1.4788 | 0.9203 | | |
| | STOP | | 0.3092 | | |
| 4 | R3* | −6.1089 | 1.1785 | 1.53 | 56.00 |
| 5 | R4* | −2.4136 | 8.9414 | | |
| 6 | IMA | ∞ | | | |

*represents aspherical surface

The object side optical surface of the first lens 111, the image side optical surface of the first lens 112, the object side optical surface of the second lens 121 and the image side optical surface of the second lens 122 are all aspherical surfaces constituted by means of the aspherical surface formula (8) whose aspherical coefficients are shown as below in Table 6.

TABLE 6
Optical Parameter Table of Third Embodiment

| Optical | | | | | | | |
|---|---|---|---|---|---|---|---|
| Surface | k | A4 | A6 | A8 | A10 | A12 | A14 |
| R1* | −5.4762E−01 | 7.8691E−03 | 6.5893E−03 | 8.1391E−04 | −2.4116E−03 | 1.5234E−03 | −2.9782E−04 |
| R2* | −3.0733E+00 | 1.4634E−01 | −7.0705E−02 | 9.8331E−02 | −7.6657E−02 | 3.8971E−02 | −8.1081E−03 |
| R3* | 1.3253E+01 | −1.7380E−02 | 2.8386E−02 | −3.8668E−02 | 1.6915E−02 | 2.3641E−03 | −2.5576E−03 |
| R4* | 9.0059E−01 | 5.7301E−03 | −1.0655E−02 | 9.9435E−03 | −4.8553E−03 | 1.0982E−03 | −7.4782E−05 |

In the reading optical lens module of the third embodiment, the focal length of the entire the reading optical lens module 10 is f=7.84 (mm), the f-number of the constructed the reading optical lens module is Fno=3.2, and the diagonal angle for the field of view (FOV) is 2ω=88.3 (in unit of degrees).

Refer back to Table 5, wherein, in the present embodiment, the dispersion coefficient for the first lens 11 of the reading optical lens module is represented as v_{d1}, the dispersion coefficient for the second lens 12 is represented as v_{d2}, with the following relationship: |v_{d1}−v_{d2}|/v_{d1}<0.065, which satisfies condition (7), as using the same material in design of the two lenses. On the optical axis, the distance from the object side optical surface of the first lens 111 to the imaging surface 14 is TL=12.05, and the half of the diagonal length in the effective sensing area of the image sensor is D_{1/2}=7.215, with TL/D_{1/2}=1.67 which satisfies condition (2). The back focal length of the reading optical lens module of the present embodiment is BFL=7.23, with BFL/TL=0.60 which satisfies condition (6). Furthermore, the focal length of the first lens 11 is f₁=588.1 and the focal length of the second lens 12 is f₂=6.80, with |f/f₁|+|f/f₂|=1.167 which satisfies condition (3).

Referring to Table 5, in the present embodiment, the first lens 11 and the second lens 12 respectively satisfies conditions (4) and (5): R₁/R₂=1.157 and (R₃+R₄)/(R₃−R₄)=2.306.

It can be seen from the optical data listed in Table 5 and the astigmatic aberration curve shown in FIG. 6 that, through the present embodiment of the image reading lens module for the barcode reader machine according to the present invention, the astigmatic field curving and the distortion can be better compensated and a wider angle of view in the image reading lens module can be well provided thereby offering the desirable effect of total length reduction.

The aforementioned descriptions are exemplary rather than being restrictive. All effectively equivalent changes, alternation or substitutions made thereto without departing from the spirit and scope of the present invention are deemed to be encompassed by the present invention as delineated in the following claims.

What is claimed is:

1. A reading optical lens module, along the optical axis and sequentially arranged from the object side to the image side, comprising: a first lens, a second lens and an image sensor;
wherein the first lens is a meniscus lens whose object side optical surface is a convex surface, and the object side optical surface and the image side optical surface of the first lens are both aspherical surfaces;
wherein the second lens is a meniscus lens whose object side optical surface is a concave surface, and the object side optical surface and the image side optical surface of the second lens are both aspherical surfaces;
wherein the first lens and the second lens are made of the same material;
wherein the image sensor is disposed on an imaging plane formed after combination of the first lens and the second lens;
satisfying the following conditions:
62.0°<2ω<89.5° and
1.50<TL/D_{1/2}<2.20,
wherein 2ω denotes the diagonal angle of the field of view for the reading optical lens module(in degrees), TL denotes the distance between the object side optical surface of the first lens and the imaging plane, and D_{1/2} represents half of the length of the diagonal line in the effective sensing area provided by the image sensor.

2. The reading optical lens module according to claim 1, further comprising an aperture stop installed between the first lens and the second lens.

3. The reading optical lens module according to claim 2, further satisfying the following condition:
0.58<BFL/TL<0.79,
wherein BFL denotes the back focal length of the reading optical lens module, and TL denotes the distance from the object side optical surface of the first lens to the imaging plane on the optical axis.

4. The reading optical lens module according to claim 1, further satisfying the following condition:
1.0<|f/f|+|f/f₂|<2.1,
wherein f denotes the focal length of the reading optical lens module, f₁ denotes the focal length of the first lens and f₂ denotes the focal length of the second lens.

5. The reading optical lens module according to claim 1, further satisfying the following condition:

|v_{d1}−v_{d2}|/v₁<0.08,
wherein v_{d1} denotes the dispersion coefficient of the first lens and v_{d2} denotes the dispersion coefficient of the second lens.

6. The reading optical lens module according to claim 5, wherein the first lens and the second lens are preferably made of the material having the same dispersion coefficient.

7. The reading optical lens module according to claim 1, further satisfying the following condition:
1.10<R₁/R₂<1.50,
wherein R₁ denotes the paraxial radius of curvature on the object side optical surface of the first lens and R₂ denotes the paraxial radius of curvature on the image side optical surface of the first lens.

8. The reading optical lens module according to claim 1, further satisfying the following condition:
1.35<(R₃+R₄)/(R₃−R₄)<2.50,
wherein R₃ denotes the paraxial radius of curvature on the object side optical surface of the second lens and R₄ denotes the paraxial radius of curvature on the image side optical surface of the second lens.

9. A reading optical lens module, along the optical axis and sequentially arranged from the object side to the image side, comprising: a first lens, an aperture stop, a second lens and an image sensor;
wherein the first lens is a meniscus lens whose object side optical surface is a convex surface, and the object side optical surface and the image side optical surface of the first lens are both aspherical surfaces;
wherein the second lens is a meniscus lens whose object side optical surface is a concave surface, and the object side optical surface and the image side optical surface of the second lens are both aspherical surfaces;
wherein the first lens and the second lens are made of the same material;
wherein the image sensor is disposed on an imaging plane formed after combination of the first lens and the second lens;
satisfying the following conditions:
62.0°<2ω<89.5°,
1.50<TL/D_{1/2}<2.20,
0.58<BFL/TL<0.79,
1.0<|f/f₁|+|f/f₂|<2.1,

|v_{d1}−v_{d2}|/v_{d1}<0.08,
1.10<R₁/R₂<1.50,
1.35<(R₃+R₄)/(R₃−R₄)<2.50,
wherein 2ω denotes the diagonal angle of the field of view for the reading optical lens module(in degrees), TL denotes the distance between the object side optical surface of the first lens and the imaging plane, D1/2 represents half of the length of the diagonal line in the effective sensing area provided by the image sensor, BFL denotes the back focal length of the reading optical lens module, f denotes the focal length of the reading optical lens module, f1 denotes the focal length of the first lens, f2 denotes the focal length of the second lens, vd1 denotes the dispersion coefficient of the first lens, vd2 denotes the dispersion coefficient of the second lens, R1 denotes the paraxial radius of curvature on the object side optical surface of the first lens, R2 denotes the paraxial radius of curvature on the image side optical surface of the first lens, R3 denotes the paraxial radius of curvature on the object side optical surface of the second lens and R4 denotes the paraxial radius of curvature on the image side optical surface of the second lens.
